(19) United States
(12) Patent Application Publication
(10) Pub. No.: US 2025/0108903 A1
(43) Pub. Date: Apr. 3, 2025

(54) AIRCRAFT DOOR MECHANISM

(71) Applicant: DASSAULT AVIATION, PARIS (FR)

(72) Inventor: Patrick CHAMBERS, MERIGNAC CEDEX (FR)

(21) Appl. No.: 18/903,545

(22) Filed: Oct. 1, 2024

(30) Foreign Application Priority Data
Oct. 2, 2023 (FR) FR 2310510

(51) Int. Cl. B64C 1/14

(52) U.S. Cl. CPC B64C 1/143; B64C 1/1461

(57) ABSTRACT

An aircraft door mechanism includes at least an aircraft structure that delimits an opening, and an aircraft door mounted so as to be movable relative to the structure between a closed position that closes the opening, and a boarding position, in which the door is arranged away from the opening and in which passengers are able to board the aircraft structure through the opening. The aircraft door mechanism includes also a control system configured so as to control the execution of a closing operation and the execution of an opening operation of the door, the control system including a drive shaft, with the control system being configured so as to control the execution of said operations by means of continuous rotation of the drive shaft relative to the aircraft structure.

The present disclosure relates to an aircraft door mechanism.

The mechanism is intended in particular for use on a civil aviation aircraft, for example a business jet.

### BACKGROUND

In known business jet models, the passenger doors open outwards with a downwards rotational movement, given that they incorporate stairs to enable passengers to climb aboard the aircraft. There are currently two major product families of passenger doors in business aviation, namely doors with mechanical operation and electrical lift, and doors with fully electrical operation.

In the case of doors with mechanical operation and electrical lift, the associated mechanisms typically have interior and exterior handles and incorporate the means for latching, latch locking, as well as the kinematics of the door. The mechanisms are operated and supported manually by an operator, and only the lifting of the door is effected entirely electrically.

However, the known mechanisms for these doors do not provide complete satisfaction.

In fact, these mechanisms carry a great deal of weight, due to the structure required to support the various parts of the mechanism. They also involve a high level of complexity, which implies high manufacturing and maintenance costs. These mechanisms also occupy a significant physical footprint, suffer from poor ergonomics, poor perceived quality due to their mechanical parts being visible, and a reduction in the useful width of the door due to the interior handle.

These mechanisms also result in poor acoustic insulation of the door from the external environment.

In fact, the relevant regulations require compliance with certain safety measures relating to the pressurisation of the aircraft. In certain known door mechanisms, these safety measures are ensured by the presence of pressure and ventilation safety flaps. The pressure safety flaps (also known as ‘pressure flaps’) are designed to prevent a passenger from opening the door when the aircraft is pressurised above a certain level. The ventilation safety flaps (also known as ‘vent flaps’) are designed to prevent pressurisation of the aircraft if the door is not closed, latched and securely locked.

However, in the known mechanisms, these valves/flaps are built-in within the door. Thus, the regulations require the presence of holes in the casing of the door in order to allow the air from the cabin to pass through and thereby ensure the functional operation of these flaps, which also allows the noise associated with the vibrations of the door to pass through.

As regards fully electrically operated doors, the associated mechanisms typically have a single button that triggers the opening or lifting of the door, along with different actuators to respectively perform each of the functions of latching, latching locking, kinematics and lifting.

However, the known mechanisms for these fully electrical doors do not offer complete satisfaction.

In particular, these mechanisms have drawbacks that are substantially identical to those mentioned above for mechanically operated mechanisms. In fact, these mechanisms also contribute considerable weight and occupy a large physical footprint, given that there is only a limited reduction in the number of parts as compared to mechanically-operated mechanisms. They also result in the door being acoustically poorly insulated against the exterior environment, for the same reasons as mentioned above.

These mechanisms also come with their own specific drawbacks, namely a high level of complexity and a low level of robustness. In fact, currently known mechanisms include at least three different actuators, for respectively executing each of the functions, which must be synchronised in order to ensure proper operation. As a result, manufacturing and maintenance costs are high.

### SUMMARY

One objective of the present disclosure is therefore to offer an aircraft door mechanism that makes it possible to overcome all or some of the above-mentioned drawbacks.

To this end, the object of the present disclosure relates to an aircraft door mechanism comprising at least:
an aircraft structure that delimits an opening;
an aircraft door mounted so as to be movable relative to the structure between a closed position, in which the door closes the opening, and a boarding position, in which the door is arranged away from the opening and in which passengers are able to board the aircraft structure through the opening;
a control system configured so as to control the execution of a closing operation and the execution of an opening operation of the door, the door closing operation successively comprising: a door movement phase of moving the door relative to the aircraft structure from the boarding position to the closed position; a door latching phase of latching the door in the closed position; and a latch locking phase of locking the latching of the door; the door opening operation successively comprising: a latch unlocking phase of unlocking the latch of the door in the closed position, an unlatching phase of unlatching the door, and a door movement phase of moving the door relative to the aircraft structure from the closed position to the boarding position;
the control system comprising a drive shaft, with the control system being configured so as to control the execution of the said operations by means of continuous rotation of the drive shaft relative to the aircraft structure.

The mechanism according to the present disclosure may comprise one or more of the following characteristic features, taken into consideration in isolation or according to any technically feasible combination:
the drive shaft is arranged away from the aircraft door;
the control system also comprises at least one mechanical chain that joins the drive shaft to the door, a latching system for latching the door in the closed position, and a latch locking system for locking the latch of the door in the closed position;
the mechanical chain has a coupling mode for coupling the rotation of the drive shaft to the movement of the door, during each door movement phase of the door closing and opening operations; and a decoupling mode for decoupling the door from the rotation of the drive shaft, during the door latching phase and the door latch locking phase of the closing operation, and during the door latch unlocking phase and the door unlatching phase of the opening operation, the mechanical chain being configured such that the rotation of the drive shaft relative to the aircraft structure drives the switching of the mechanical chain from one of the modes to the other;
the mechanical chain comprises a lifting shaft, a control-lift connection system between the drive shaft and the lifting shaft, and a lift-door linking system between the lifting shaft and the door;
the control-lift connection system comprises at least one pair of connection members, the pair of connection members comprising a control connection member that is fixed to the drive shaft; and a lift connection member that is fixed to the lifting shaft, the control connection member and the lift connection member being capable of rotationally coupling the drive shaft and the lifting shaft in the coupling mode and of decoupling the lifting shaft from the rotation of the drive shaft in the decoupling mode;
either one of the control connection member and the lift connection member comprises a connection roller, while the other one of the control connection member and the lift connection member comprises a connection track that is capable of receiving the connection roller;
the connection track comprises a coupling travel such that, in the coupling mode of the mechanical chain, the coupling travel and the connection roller are capable of rotationally coupling the drive shaft and the lifting shaft, and such that, in the decoupling mode of the mechanical chain, the roller is outside the coupling travel; the connection track also preferably comprising a dead travel, the dead travel being such that, in the decoupling mode of the mechanical chain, the connection roller is either received in the dead travel or is outside the connection track;
the lift-door linking system comprises at least one pair of linking members, the pair of linking members comprising a lift linking member that is fixed to the lifting shaft, and a door linking member that is fixed to the door, the lift linking member being articulated to the door linking member;
the latching system has a latching configuration for latching the door in the closed position, in which the latching system blocks the mechanical chain; and an unlatching configuration for unlatching the door in the closed position, in which the latching system does not obstruct the mechanical chain, the latching system being configured so as to ensure that rotation of the drive shaft relative to the aircraft structure drives the switching of the latching system from one of the configurations to the other;
the latching system comprises at least one latching surface for the mechanical chain, a latch that is movable relative to the mechanical chain and to the drive shaft, and a drive section of the drive shaft that is capable of driving the latch, with the latching surface preferably being formed by the lifting shaft;
the shape and form of the latching surface, the latch, and the shape and form of the drive section of the drive shaft are configured together so as to ensure that the latching system is maintained in the said configurations and so as to ensure the said switches of the latching system from one of the configurations to the other, by means of rotation of the drive shaft relative to the aircraft structure;
the latch locking system has a latch locking configuration for locking the latch of the door in the closed position, and a latch unlocking configuration, the latch locking system being configured such as to ensure that the rotation of the drive shaft relative to the aircraft structure drives the switching of the latch locking system from one of the configurations to the other;
the latch locking system comprises at least one latch locking member that is fixed to the latch, and a latch locking cam for the latch that is fixed to the drive shaft, the shapes and forms of the latch locking member and of the latch locking cam being configured together in order to ensure that the latch locking system is maintained in the said configurations and in order to ensure the said switches of the latch locking system from one of the configurations to the other, by means of rotation of the drive shaft relative to the aircraft structure;
the control system also comprises a pressure safety system, the pressure safety system comprising at least one ventilation opening delimited by the aircraft structure; a safety flap that is movable relative to the aircraft structure between a closed position which closes the ventilation opening and a ventilation position arranged away from the ventilation opening; and a drive device for driving the safety flap between the closed and ventilation positions, the drive device being configured so as to ensure the switching of the safety flap from one of the said positions to the other, by means of rotation of the drive shaft relative to the aircraft structure;
the control system also comprises an actuator that is capable of effectuating rotation of the drive shaft relative to the aircraft structure in order to control the execution of the said operations by means of continuous rotation of the drive shaft, the actuator preferably being electrical;
the control system also comprises an interior handle on the interior of the aircraft structure, the control system being configured such that actuation of the interior handle effectuates rotation of the drive shaft relative to the aircraft structure in order to control the execution of the said operations; and/or the control system also comprises an exterior handle on the exterior of the aircraft structure, the control system being configured such that actuation of the exterior handle effectuates rotation of the drive shaft relative to the aircraft structure in order to control the execution of the said operations.

The present disclosure also relates to an aircraft that includes the mechanism as described above.

Independently of the above characteristic features, the present disclosure also relates to an aircraft door mechanism comprising at least:
an aircraft structure that delimits an opening;
an aircraft door mounted so as to be movable relative to the structure between a closed position, in which the door closes the opening, and a boarding position, in which the door is arranged away from the opening and in which passengers are able to board the aircraft structure through the opening;
a control system configured so as to control the execution of a closing operation and the execution of an opening operation of the door, the control system comprising a pressure safety system, the pressure safety system comprising at least one ventilation opening delimited by the aircraft structure; a safety flap that is movable relative to the aircraft structure between a closed position which closes the ventilation opening and a ventilation position arranged away from the safety opening; and a drive device for driving the safety flap between the closed and ventilation positions.

### SUMMARY OF THE DRAWINGS

The present disclosure will become more clearly apparent from the description which follows, provided solely by way of non-limiting example, and made with reference to the drawings in which:

FIG. 1 is a perspective view of an embodiment of the aircraft door mechanism, when the door is in the boarding position;

FIGS. 2 and 3 are perspective views of the aircraft door mechanism shown in FIG. 1, with the door being in the closed position;

FIG. 4 comprises cross-sectional views A, B, C of the mechanical chain and guidance systems, when the door is in the boarding position;

FIG. 5 comprises the same views as in FIG. 4, when the door is at the end of the rotation stage of the door movement phase of the door closing operation;

FIG. 6 comprises the same views as in FIG. 4, when the door is in the closed position;

FIG. 7 comprises the cross-sectional views of the mechanical chain, when the latching system is in the unlatching configuration (view A) and in the latching configuration (view B);

FIG. 8 comprises the cross-sectional views of the latching system, in the unlatching configuration (view A) and in the latching configuration (view B);

FIG. 9 comprises the cross-sectional views of the latch locking system, in the latch unlocking configuration (view A) and in the latch locking configuration (view B); and

FIG. 10 comprises the cross-sectional views of the safe pressurisation system, in the depressurisation configuration (view A) and in the safe-pressurisation configuration (view B).

### DETAILED DESCRIPTION

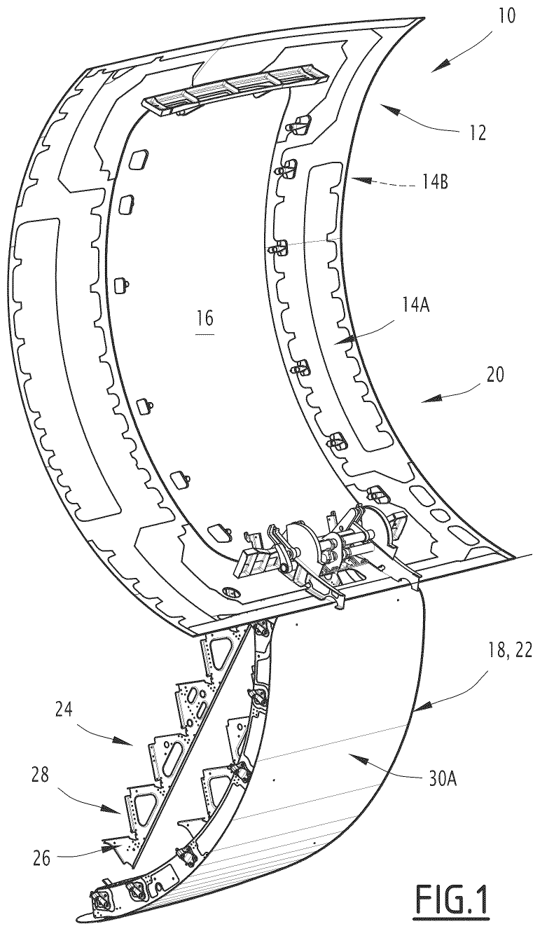

The present disclosure relates to an aircraft comprising an aircraft door mechanism 10 as illustrated in FIGS. 1 to 3.

The aircraft preferably has a maximum takeoff weight (MTOW) of less than 55,000 kg.

In addition, the aircraft is advantageously configured for a maximum number of passengers permissible on board (PAX) being less than or equal to 19.

The aircraft is for example, a business jet.

The aircraft comprises of a structure 12, hereinafter referred to as the “aircraft structure”.

The aircraft structure 12 is for example a fuselage.

The aircraft structure 12 has an exterior surface 14A and an interior surface 14B.

The exterior surface 14A is in contact with an air mass on the exterior of the aircraft. The interior surface 14B delimits an interior volume.

For example, the aircraft structure 12 defines an entrance space for passengers to enter into the aircraft. Preferably, the aircraft structure 12 also additionally defines a cockpit and a passenger cabin, with the entrance space interposed longitudinally between the cockpit and the cabin.

The cockpit refers to the reserved space restricted to crew members who make up the flight crew, such as the pilot and the co-pilot. The cockpit is located at the front end of the aircraft structure 12. In a known manner it includes the instrumentation designed for piloting and managing the aircraft, as well as the seats for accommodating the pilot and co-pilot.

The cabin is designed to accommodate the passengers of the aircraft during a flight phase of the aircraft. It typically comprises the seats for accommodating the passengers during the flight. Advantageously, the cabin includes other items of furniture/furnishings such as tables or tray tables.

In addition, the aircraft structure 12 delimits a passenger opening 16 for passengers to pass through.

The opening 16 leads into the passenger entrance space.

The opening 16 has the appropriate dimensions to allow passengers to enter the interior of the aircraft structure 12 from outside the aircraft structure 12.

To achieve this, the opening 16 is a through opening. It thus joins the exterior surface 14A to the interior surface 14B of the aircraft structure 12.

The opening 16 has a substantially rectangular shaped form, with rounded corners.

The aircraft door mechanism 10 comprises at least the said aircraft structure 12, an aircraft door 18, and a control system 20.

The aircraft door mechanism 10 also optionally comprises at least one door status sensor system for detecting the status of the door 18, and/or a visual door status indicator for indicating the status of the door 18, and/or an emergency opening system.

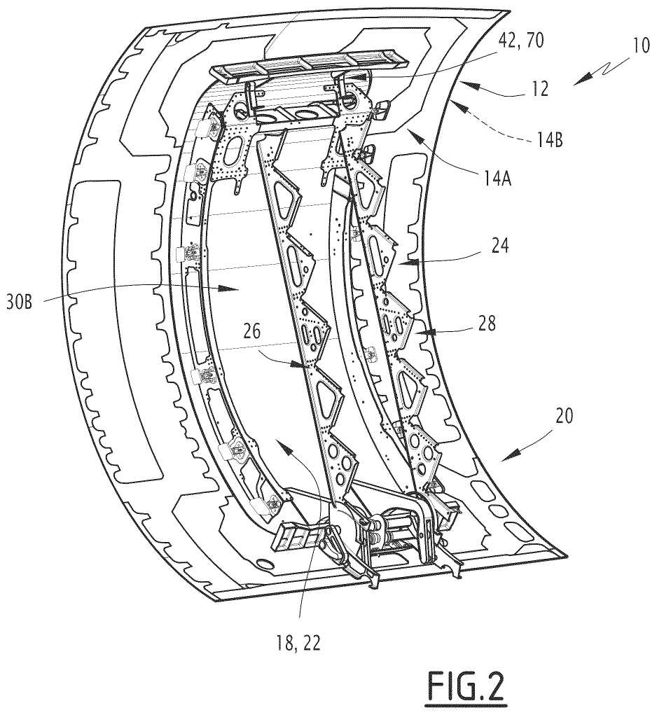

As indicated above the door 18 is a passenger boarding door, visible in FIGS. 1 and 2.

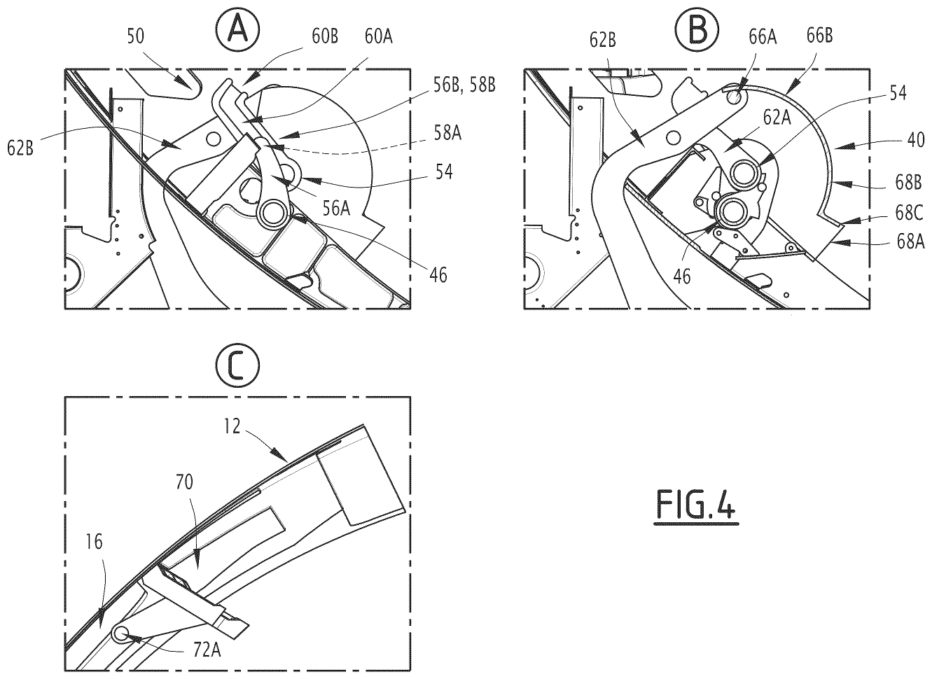

The door 18 is mounted so as to be movable relative to the aircraft structure 12 between a closed position (FIGS. 2 and 6 to 10), in which the door 18 closes off the opening 16, and a boarding position (FIGS. 1 and 4), in which the door 18 is arranged away from the opening 16 and in which passengers are able to board the aircraft structure 12 through the opening 16.

In the closed position, the door 18 closes the opening 16 in a sealed manner.

In the boarding position, the door 18 is arranged away from the opening 16.

Furthermore, in the boarding position, the door 18 and the opening 16 are not mutually superposed, as projected onto the interior surface 14B of the aircraft structure 12.

More precisely, in the boarding position, the door 18 is disposed entirely below the opening 16, as projected in a vertical plane.

The door 18 comprises at least one base 22 and, preferably, a staircase 24.

In one preferred example, in the boarding position, passengers are able to board into the aircraft structure 12 making use of the staircase 24 of the door 18.

The base 22 is adapted so as to be applied against the aircraft structure 12 when the door 18 is in the closed position.

The base 22 presents an exterior contour having, for example, dimensions that are substantially equal to those of the opening 16, as projected onto the aircraft structure 12.

The staircase 24 comprises two railings 26 and steps 28, the steps 28 being supported by the railings 26. The railings 26 are attached to the base 22.

In the boarding position, the steps 28 are oriented in a manner such that passengers can use them for boarding the aircraft (FIG. 1).

The door 18 has an exterior face 30A and an interior face 30B.

When the door 18 is in the closed position, the exterior face 30A of the door 18 is in contact with the mass of air on the exterior of the aircraft.

In particular, the exterior face 30A of the door 18 is flush with the exterior surface 14A of the aircraft structure 12, when the door 18 is in the closed position.

The control system 20 is configured so as to control the execution of a closing operation and the execution of an opening operation of the door 18.

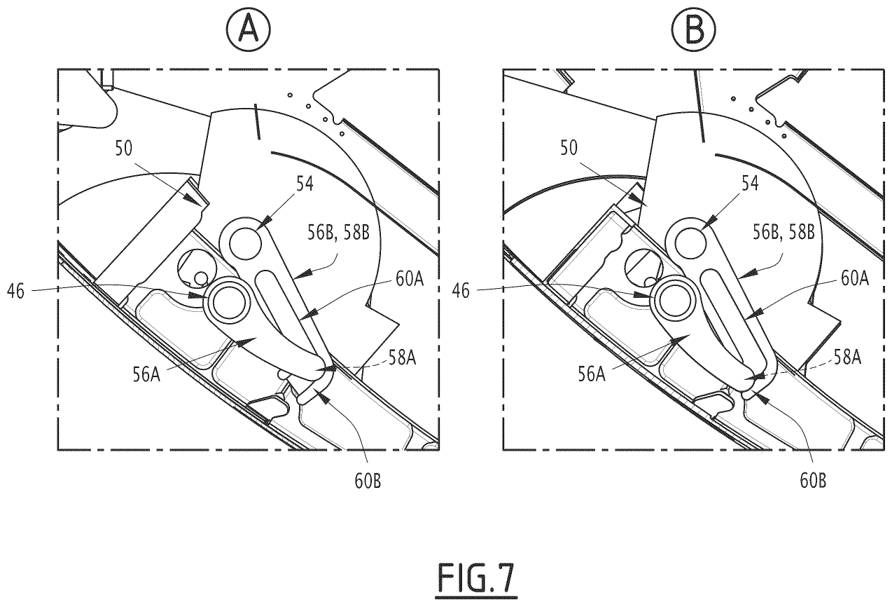

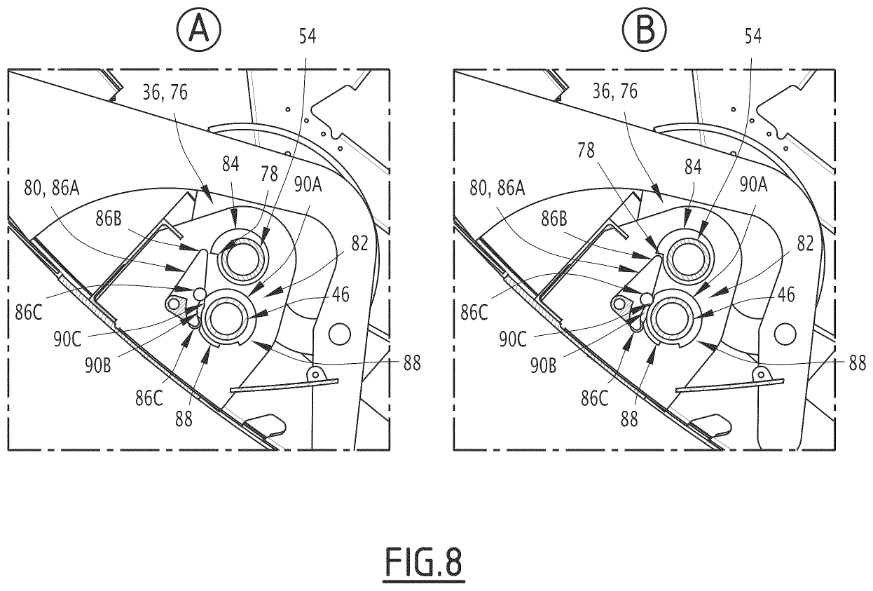

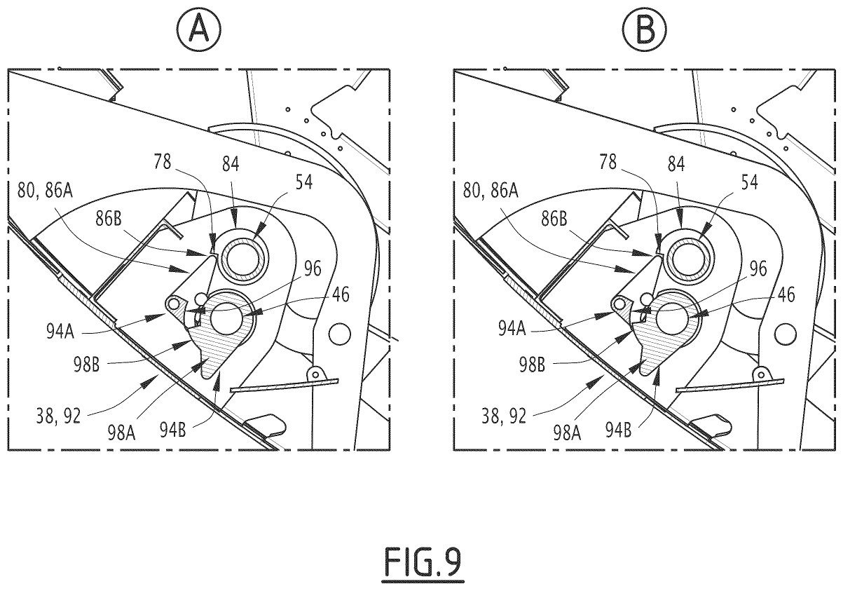

The door closing operation successively comprises: a door movement phase of moving the door 18 relative to the aircraft structure 12 from the boarding position to the closed position (FIGS. 4 to 6); a door latching phase of latching the door 18 in the closed position (FIGS. 7 to 8); and a latch locking phase of locking the door latch (FIG. 9).

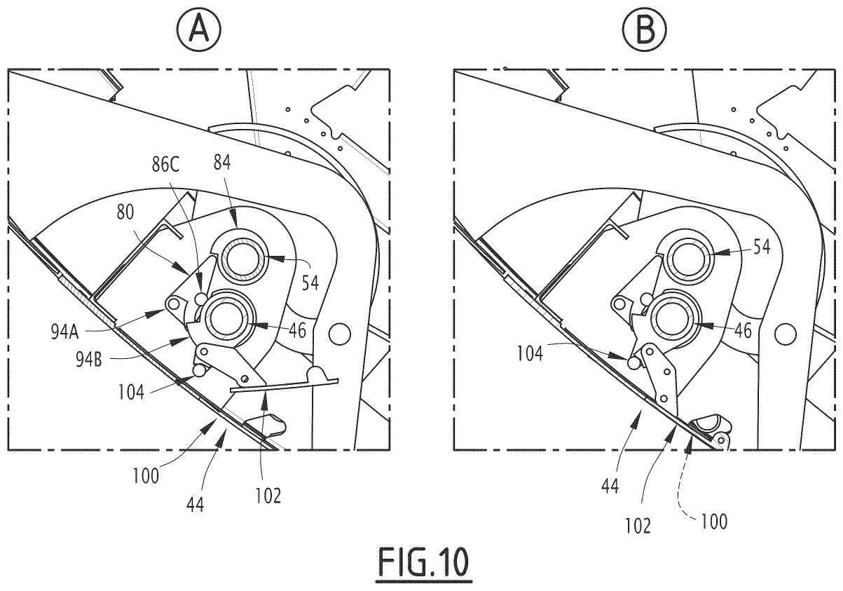

Preferably, the door closing operation also includes a safe pressurisation phase for safely pressurising the aircraft (FIG. 10), after the latch locking phase.

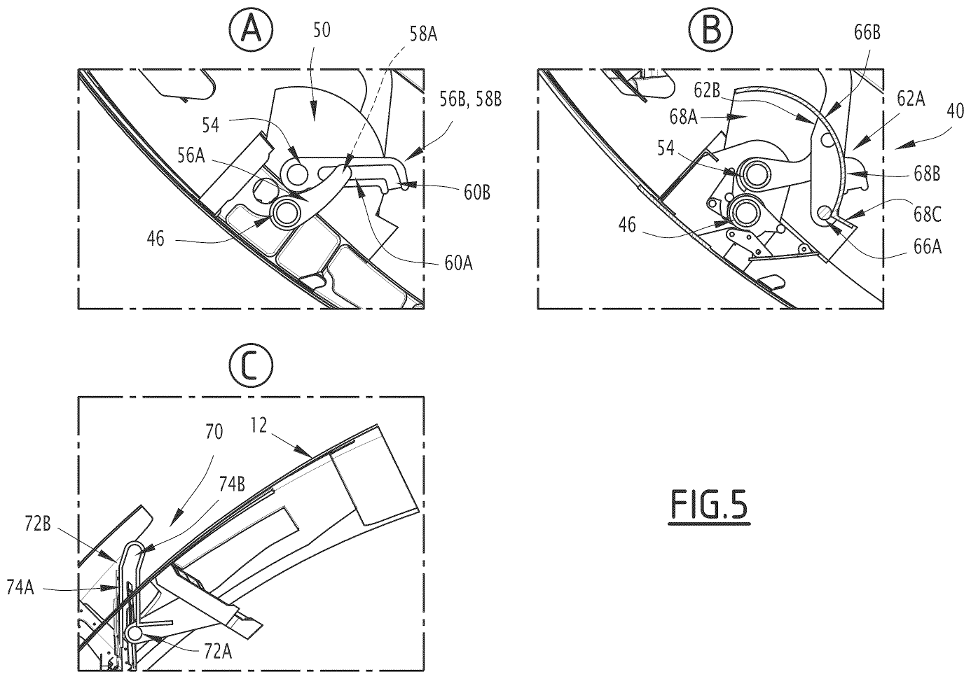

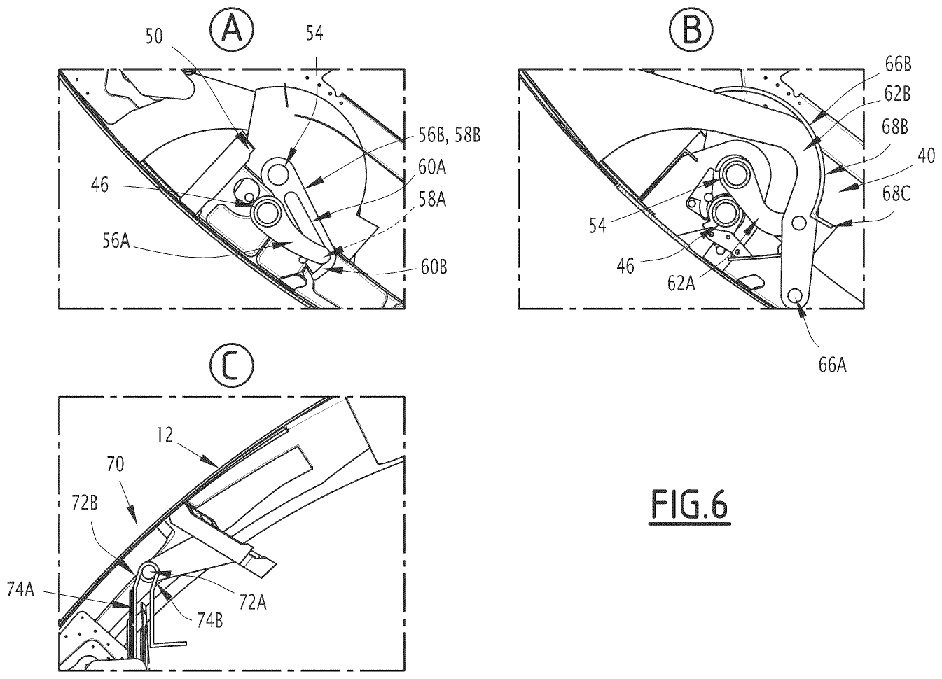

The door movement phase of the door closing operation preferably comprises of a rotation step of rotating the door from the boarding position (FIGS. 4 to 5), followed by a lowering step of lowering the door to the closed position (FIGS. 5 to 6).

The door opening operation successively comprises of a door latch unlocking phase of unlocking the latch of the door 18 in the closed position, an unlatching phase of unlatching the door 18, and a door movement phase of moving the door 18 relative to the aircraft structure 12 from the closed position to the boarding position (FIGS. 6 to 4).

Preferably, the opening operation also includes a depressurisation phase of depressurising the aircraft, prior to the door latch unlocking phase.

The door movement phase of the opening operation preferably includes a lifting step of lifting the door from the closed position (FIGS. 6 to 5), followed by a rotation step of rotating the door to the boarding position (FIGS. 5 to 4).

The control system 20 comprises a drive shaft 32, the control system 20 being configured so as to control the execution of the said operations by means of continuous rotation of the drive shaft 32 relative to the aircraft structure 12.

The term “continuous rotation” is understood to indicate that the rotation of the drive shaft 32 is not interrupted during the execution of the said operations.

The control system 20 is without any other rotary drive shaft for controlling the execution of the door opening and closing operations.

The control system 20 is configured so as to control the execution of the door closing operation by means of continuous rotation of the drive shaft 32 relative to the aircraft structure 12 in a direction of rotation of door closing.

The control system 20 is also configured so as to control the execution of the door opening operation by means of continuous rotation of the drive shaft 32 relative to the aircraft structure 12 in a direction of rotation of door opening, which is opposite to the direction of rotation of door closing.

Preferably, the control system 20 is configured so as to control the execution of the said operations by means of continuous rotation of the drive shaft 32, relative to the aircraft structure 12, over less than one complete revolution of the drive shaft 32 about its control axis.

Preferably, the control system 20 is configured so as to control the execution of the said operations by means of continuous rotation of the drive shaft 32 at a constant rotational speed.

The control system 20 also comprises an actuator that is capable of effectuating rotation of the drive shaft 32 in order to control the execution of the said operations by means of continuous rotation of the drive shaft 32.

Furthermore, in the preferred embodiment illustrated, the control system 20 also comprises at least one mechanical chain 34 that joins the drive shaft 32 to the door 18; a latching system 36 for latching the door 18 in the closed position; and a latch locking system 38 for locking the latch of the door 18 in the closed position.

Advantageously, the control system 20 also comprises a rotation guidance system 40 and/or a lifting-lowering guidance system 42.

The control system 20 moreover preferably comprises a pressure safety system 44.

The drive shaft 32 extends along a control axis and is rotationally movable along the control axis relative to the aircraft structure 12.

In particular, the drive shaft 32 is rotationally movable along the control axis relative to the aircraft structure 12 at least between an angular boarding position, corresponding to the angular position of the drive shaft 32 when the door 18 is in the boarding position, and an angular latched and locked position corresponding to the angular position of the drive shaft 32 at the end of the latch locking phase.

In the embodiment where the door closing and opening operations in addition respectively comprise a safe pressurisation phase and a depressurisation phase, the drive shaft 32 is movable relative to the aircraft structure 12 at least between the angular boarding position and an angular safe pressurisation position corresponding to the angular position of the drive shaft 32 at the end of the phase of blocking safe pressurisation.

The drive shaft is stationary relative to the aircraft structure 12.

The drive shaft is therefore immovable relative to the aircraft structure 12 during any movement of the door 18 relative to the aircraft structure 12.

More generally, the control axis is immovable relative to the aircraft structure 12 during all door closing and opening operations.

The drive shaft 32 is arranged away from the aircraft door 18.

The drive shaft 32 is arranged away from the opening 16.

The drive shaft 32 is thus in particular disposed offset over the frame of the door 18.

For example, the drive shaft 32 is disposed below the opening 16.

In particular, the drive shaft 32 comprises a control rod 46 extending along the control axis.

The control rod 46, for example, is cylindrical with a constant radius.

The control axis passes through the middle of the cross-sectional area of the control rod 46.

For reasons of clarity, the actuator is not illustrated in the figures.

The actuator is capable of effectuating rotation of the control shaft 32 along the control axis relative to the aircraft structure 12.

The actuator is directly connected to the drive shaft 32.

The actuator is capable of converting energy received into rotation of the drive shaft 32 relative to the aircraft structure 12.

The actuator is, for example, electrical, hydraulic or pneumatic.

In the electrical embodiment, the actuator comprises, for example, a rotary motor or a linear motor.

In the hydraulic or pneumatic embodiment, the actuator comprises, for example, a cylinder.

The mechanical chain 34 is configured so as to convert the rotation of the drive shaft 32 into movement of the door 18 during each door movement phase.

The mechanical chain 34 preferably has a coupling mode for coupling the rotation of the drive shaft 32 to the movement of the door 18 (FIGS. 4 to 6), during each door movement phase of the door closing and opening operations; and a decoupling mode for decoupling the door 18 from the rotation of the drive shaft 32 (FIG. 7), during the door latching phase and the door latch locking phase of the closing operation, and during the door latch unlocking phase and the door unlatching phase of the opening operation.

More precisely, in the coupling mode, the mechanical chain 34 is configured such that rotation of the drive shaft 32 relative to the aircraft structure 12 along the control axis drives the movement of the door 18 relative to the aircraft structure 12.

In the decoupling mode, the mechanical chain 34 is configured such that the rotation of the drive shaft 32 relative to the aircraft structure 12 along the control axis does not drive any movement of the door 18 relative to the aircraft structure 12.

The mechanical chain 34 is configured such that the rotation of the drive shaft 32 relative to the aircraft structure 12 drives the switching of the mechanical chain 34 from one of the modes to the other.

More precisely, the mechanical chain 34 is configured such that rotation of the drive shaft 32 relative to the aircraft structure 12 in the closing rotational direction drives the switching of the mechanical chain 34 from the coupling mode to the decoupling mode.

Conversely, the mechanical chain 34 is configured such that rotation of the drive shaft 32 relative to the aircraft structure 12 in the opening rotational direction drives the switching of the mechanical chain 34 from the decoupling mode to the coupling mode.

In the preferred embodiment illustrated, the mechanical chain 34 is reversible.

The term ‘reversible’ is understood to indicate that the mechanical chain 34 is also capable of converting the movement of the door 18 into rotation of the drive shaft 32.

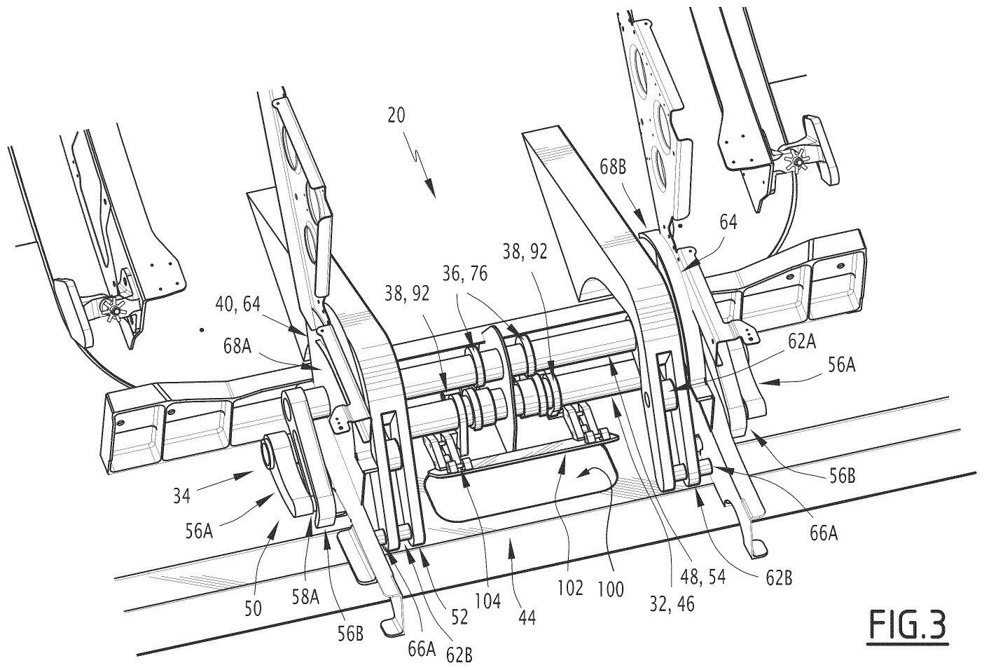

In the preferred embodiment shown in FIG. 3, the mechanical chain 34 comprises a lifting shaft 48, a control-lift connection system 50 between the drive shaft 32 and the lifting shaft 48, and a lift-door linking system 52 between the lifting shaft 48 and the door 18.

The lifting shaft 48 is distinct from the drive shaft 32.

The lifting shaft 48 extends along a lifting axis and is rotationally movable along the lifting axis relative to the aircraft structure 12.

The lifting axis is stationary relative to the aircraft structure 12.

The lifting axis is thus immovable relative to the aircraft structure 12 during all the closing and opening operations.

The lifting axis is preferably parallel to the control axis.

The lifting and control axes are mutually offset from each other.

The lifting shaft 48 is thus offset over the frame of the door 18.

For example, the lifting shaft 48 disposed below the opening 16.

The lifting shaft 48 comprises a lifting rod 54, extending along the lifting axis.

The lifting rod 54, for example, is cylindrical with a constant radius.

The lifting axis passes through the middle of the cross-sectional area of the lifting rod 54.

The control-lift connection system 50 is capable of ensuring deployment of the coupling mode and the decoupling mode of the mechanical chain 34.

In the coupling mode of the mechanical chain 34 (views A of FIGS. 4 to 7), the control-lift connection system 50 rotationally couples the drive shaft 32 and the lifting shaft 48.

More precisely, in the coupling mode of the mechanical chain 34, the control-lift connection system 50 is thus configured such that rotation of the drive shaft 32 relative to the aircraft structure 12 along the control axis drives rotation of the lifting shaft 48 relative to the aircraft structure 12 along the lifting axis.

Preferably, the lifting shaft 48 is thus then able to be driven in the same direction of rotation about the lifting axis as the direction of rotation of the drive shaft 32 about the control axis.

In the decoupling mode of the mechanical chain 34 (view B of FIG. 7), the control-lift connection system 50 decouples the lifting shaft 48 from the rotation of the drive shaft 32.

More precisely, in the decoupling mode of the mechanical chain 34, the control-lift connection system 50 is thus then configured such that rotation of the drive shaft 32 relative to the aircraft structure 12 along the control axis does not drive the lifting shaft 48 in rotation relative to the aircraft structure 12.

To this end, the control-lift connection system 50 comprises at least one pair of connection members, the pair of connection members comprising a control connection member 56A that is fixed to the drive shaft 32; and a lift connection member 56B that is fixed to the lifting shaft 48.

The control-lift connection system 50 comprises, for example, at least two separate redundant pairs of connection members 56A-56B. The two or more redundant pairs of connection members 56A-56B are arranged at a distance from each other along the control axis.

For each pair of connection members 56A-56B, the control connection member 56A and the lift connection member 56B are capable of rotationally coupling the drive shaft 32 and the lifting shaft 48 in the coupling mode and of decoupling the lifting shaft 48 from the rotation of the drive shaft 32 in the decoupling mode.

The control connection member 56A is integral in rotation with the control rod 46, during any rotation of the drive shaft 32 relative to the aircraft structure 12. The control connection member 56A is for example fastened to the control rod 46.

The lift connection member 56B is integral in rotation with the lifting rod 54, during any rotation of the lifting shaft 48 relative to the aircraft structure 12. The lift connection member 56B is, for example, fastened to the lifting rod 54.

The control connection member 56A comprises a base body that extends radially from the control rod 46, and the lift connection member 56B comprises a base body that extends radially from the lifting rod 54.

Either one of the control connection member 56A and the lift connection member 56B comprises a connection roller 58A, while the other one of the control connection member 56A and the lift connection member 56B comprises a connection track 58B that is capable of receiving the connection roller 58A.

In the illustrated example, the control connection member 56A comprises the connection roller 58A and the lift connection member 56B comprises the connection track 58B. However, by way of a variant not illustrated, the lift connection member 56B comprises the connection roller 58A and the control connection member 56A comprises the connection track 58B.

The connection roller 58A extends from the base body of the connection member that includes it, for example parallely to the control axis.

The connection track 58B extends from the base body of the connection member which includes it. The connection track 58B is delimited by two branches extending from the base body.

The connection track 58B comprises a coupling travel 60A and, preferably, a dead travel 60B.

In the coupling mode of the mechanical chain 34, the coupling travel 60A and the connection roller 58A are capable of rotationally coupling the drive shaft 32 and the lifting shaft 48.

More precisely, in the coupling mode, the connection roller 58A is received in the coupling travel 60A (views A of FIGS. 4 to 7). Thus, any movement of the connection roller 58A, relative to the connection track 58B, along the said coupling travel 60A drives the rotation of the lift connection member 56B along the lifting axis relative to the aircraft structure 12.

The coupling travel 60A extends for example along a directrix, the directrix being a straight line. For example, the directrix line passes through the lifting axis.

The connection track 58B is such that connection roller 58A is received in the coupling travel 60A until the door 18 reaches the closed position.

When the door 18 is in the closed position, the mechanical chain 34 switches from the coupling mode to the decoupling mode. The connection roller 58A leaves the coupling travel 60A.

In the decoupling mode of the mechanical chain 34, the connection roller 58A is outside the coupling travel 60A (view B of FIG. 7). The connection roller 58A is thus then either received in the dead travel 60B, or is outside the connection track 58A.

In the decoupling mode of the mechanical chain 34, the dead travel 60B and the connection roller 58A are capable of decoupling the lifting shaft 48 from the rotation of the drive shaft 32.

More precisely, in the decoupling mode, the dead travel 60B is such that any movement of the connection roller 58A, relative to the connection track 58B, along the said dead travel 60B does not drive any rotation of the lift connection member 56B relative to the aircraft structure 12.

The dead travel 60B extends from the coupling travel 60A while prolonging the coupling travel 60A. When the connection roller 58A leaves the coupling travel 60A, the connection roller 58A is then received in the dead travel 60B.

The dead travel 60B extends, for example, along a curved directrix along a circular arc centred on the control axis.

Preferably, the dead travel 60B of the connection track 58A is open opposite the coupling travel 60A. The connection roller 58A is thus able to exit from the connection track 58A.

Thus, during the door movement phase of the door closing operation, the rotation of the drive shaft 32 in the direction of rotation for closing is coupled to the rotation of the lifting shaft 48 by the connection roller 58A which is accommodated in the coupling travel 60A (views A of FIGS. 4 to 7), until the door 18 reaches the closed position and the connection roller 58A exits the coupling travel 60A (view B of FIG. 7). Once the closed position has been reached, the connection roller 58A reaches the dead travel 60B, and the rotation of the drive shaft 32 is decoupled from the lifting shaft 48 during the other phases of the closing operation.

Conversely, rotation of the drive shaft 32 in the direction of rotation for opening is decoupled from the lifting shaft 48 by the connection roller 58A which is outside the coupling travel 60A, during the phases other than the door movement phase of the door opening operation, until the connection roller 58A reaches the coupling travel 60A. Once the connection roller 58A reaches the coupling travel 60A, the rotation of the drive shaft 32 is coupled to the rotation of the lifting shaft 48 by the control-lift connection system 50, during the movement phase.

The lift-door linking system 52 is configured so as to join the lifting shaft 48 to the door 18.

The lift-door linking system 52 comprises at least one pair of linking members, the pair of linking members comprising a lift linking member 62A that is fixed to the lifting shaft 48, and a door linking member 62B that is fixed to the door 18, the lift linking member 62A being hinge-jointed (articulated) to the door linking member 62B.

The lift-door linking system 52 comprises, for example, at least two separate redundant pairs of linking members 62A-62B. The two or more pairs of linking members 62A-62B are arranged at a distance from each other along the control axis.

For example, the redundant pairs of linking members 62A-62B are arranged between pairs of control-lift connection members 56A-56B.

For each pair of linking members 62A-62B, the lift linking member 62A and the door linking member 62B are capable of cooperating in order to drive a movement of door 18 relative to the aircraft structure 12 during a rotation of the lifting shaft 48 relative to the aircraft structure 12 about the lifting axis.

To this end, the lift linking member 62A is hinge-jointed (articulated) to the door linking member 62B, the lifting linking member 62A and the door linking member 62B being thus attached to each other by a hinge-joint (articulation).

The lift linking member 62A is thus rotationally movable relative to the door linking member 62B along a hinge (articulation) axis that is parallel to the lift axis.

The lift linking member 62A is integral in rotation with the lifting rod 54, during any rotation of the lifting shaft 48 relative to the aircraft structure 12. For example, the lift linking member 62A is fastened to the lifting rod 54.

The lift linking member 62A preferably has a curve shaped form. In particular, the lift linking member 62A has an angular form.

The door linking member 62B is integral in rotation with the base 22 of the door 18 during the entire closing and opening operation. For example, the door linking member 62B is fastened to the base 22 of the door 18. The door linking member 62B preferably is flared towards the base 22 of the door 18 in a direction perpendicular to the control axis.

The door linking member 62B preferably has a curved form, for example an angular form.

Preferably, the angular shaped forms of the lift linking member 62A and the door linking member 62B have different concavities. They each have respective hollow parts that face each other when the door 18 is in the closed position.

In particular, these curved shapes enable the lowering step after the rotation step of the door closing operation and the lifting step before the rotation step of the door opening operation.

The curved form of the door linking member 62B is for example swan-neck shaped. In the closed position of the door 18, the door linking member 62B for example surrounds the drive shaft 32 and the lifting shaft 48.

Either one of the lift linking member 62A and the door linking member 62B comprises, for example, two branches which receive and accommodate between them, at the level of their hinged joint, the other of the lift linking member 62A and the door linking member 62B. In the example shown in FIG. 3, the two branches are incorporated in the door linking member 62B.

Thus, during the door movement phase of the closing operation, the rotation of the drive shaft 32 in the closing rotational direction is coupled to the rotation of the lifting shaft 48 by the control-lift connection system 50 (views A of FIGS. 4 to 7). The rotation of the lifting shaft 48 simultaneously drives the movement of the door 18 by the lift-door linking system 52 until such time as the door 18 reaches the closed position. Once the closed position has been reached, the lifting shaft 48 is decoupled from the rotation of the drive shaft 32 by the control-lift connection system 50 during the other phases of the closing operation (FIG. 7).

Conversely the rotation of the drive shaft 32 in the opening rotational direction does not drive any movement of the door 18 relative to the aircraft structure 12 during the phases other than the door movement phase of the opening operation. Once the rotation of the drive shaft 32 is coupled to the rotation of the lifting shaft 48 by the control-lift connection system 50, the rotation of the lifting shaft 48 simultaneously drives the movement of the door 18 by the lift-door linking system 52 during the door movement phase.

The rotation guidance system 40 is capable of guiding the rotation step of each door movement phase of the door closing and opening operations.

The rotation guidance system 40 comprises at least one rotation guidance device 64. The rotation guidance system 40 preferably comprises at least two separate redundant rotation guidance devices 64. The two or more redundant rotation guidance devices 64 are arranged some distance apart from each other along the control axis.

Preferably, the rotation guidance system 40 comprises a separate rotation guidance device 64, for each pair of linking members 62A-62B of the lift-door linking system 52.

Each rotation guidance device 64 comprises a guidance roller 66A and a rotation guidance track 66B.

Either one of the guidance roller 66A and the rotation guidance track 66B is fixed to one of the linking members 62A-62B, with the other being fixed to the aircraft structure 12. The reverse may also be envisaged.

In the illustrated example, the guidance roller 66A is fixed to one of the linking members 62A-62B while the rotation guidance track 66B is fixed to the aircraft structure 12.

The guidance roller 66A extends, from one of the linking members 62A-62B, such that it projects outwards parallel to the lifting axis.

In the illustrated example, the guidance roller 66A is fixed to the door linking member 62B. More precisely, the guidance roller 66A for example, is fixed to one of the branches of the door linking member 62B.

In addition, the guidance roller 66A for example, is arranged opposite the door 18, in relation to the hinged joint (articulation) with the lift linking member 62A.

The rotation guidance track 66B is capable of guiding the rotation of the guidance roller 66A about the lifting axis.

The rotation guidance track 66B for example, is fastened to the aircraft structure 12.

The rotation guidance track 66B is preferably immovable relative to the aircraft structure 12 during any rotation of the drive shaft 32 relative to the aircraft structure 12.

The rotation guidance track 66B delimits an arcuate rotational path for the guidance roller 66A.

To this end, the rotation guidance track 66B comprises, for example, at least one support plate 68A and one curved plate 68B which between them delimit the rotational path. The support plate 68A is planar and extends, for example, in a plane perpendicular to the lifting axis. The curved plate 68B extends from the support plate 68A and is part of a cylinder of revolution centred on the lifting axis.

During the rotation step of each door movement phase (views B of FIGS. 4 to 5), the guidance roller 66A follows the curvature of the rotational path.

The curved plate 68B has a terminal end corresponding to the position of the guidance roller 66A at the end of the rotation step of the door movement phase of the door closing operation (view B of FIG. 5).

Advantageously, the rotation guidance track 66B guides only the rotation step of each door movement phase of the closing and opening operations.

During the lowering or lifting step of each movement phase (views B of FIGS. 5 to 6), the guidance roller 66A is outside the rotational path.

Preferably, the rotational path is thus open at the terminating end of the curved plate 68B.

For example, the rotation guidance track 66B comprises an end plate 68C extending from the terminating end of the curved plate 68B. In particular, the end plate 68C extends in a direction away from the lifting axis. The end plate 68C for example is planar.

The lifting-lowering guidance system 42 is capable of guiding the respective lowering movement step or lifting movement step of the door closing and opening operations.

The lifting-lowering guidance system 42 comprises at least one lifting-lowering guidance device 70. The lifting-lowering guidance system 42 preferably comprises at least two separate redundant lifting-lowering guidance devices 70. The two or more redundant lifting-lowering guide devices 70 are arranged at a distance from each other along the control axis.

Each lifting-lowering guidance device 70 comprises a lifting-lowering guidance roller 72A and a lifting-lowering guidance track 72B.

Either one of the lifting-lowering guidance roller 72A and the lifting-lowering guidance track 72B is fixed to the door 18, with the other being fixed to the aircraft structure 12.

In the illustrated example, the lifting-lowering guidance roller 72A is fixed to the aircraft structure 12 while the lifting-lowering guidance track 72B is fixed to the door 18.

In the illustrated example, the element 72A or 72B which is fixed to the aircraft structure 12 is arranged above the opening 16. Alternatively, the element 72A or 72B which is fixed to the aircraft structure 12 is arranged on one of the lateral sides of the opening 16. In one preferred alternative, the element 72A or 72B which is fixed to the aircraft structure 12 is arranged below the opening 16, that is to say on the same side of the opening as the drive shaft 32.

The lifting-lowering guidance track 72B delimits a lifting-lowering guidance path for the lifting-lowering guidance roller 72A.

The lifting-lowering guidance path comprises, for example, a vertical section 74A and an inwardly curved section 74B, with the curved section 74B extending from the vertical section 74A.

The lifting-lowering guidance path has an opening and a bottom.

The lifting-lowering guidance path is thus open at the vertical section 74A, such that the lifting-lowering guidance roller 72A is able to enter and exit the lifting-lowering guidance path (view C of FIG. 5).

In the example illustrated in view C of FIG. 6, the lifting-lowering guidance path is also such that the lifting-lowering guidance roller 72A is in contact with the bottom of the path, when the door 18 is in the closed position. Alternatively, the lifting-lowering guidance path is such that the lifting-lowering guidance roller 72A is positioned some distance away from the bottom of the path when the door 18 is in the closed position.

During the rotation step of each door movement phase (views C of FIGS. 4 and 5), the lifting-lowering guidance roller 72A is outside the lifting-lowering guidance path.

The lifting-lowering guidance system 42 and the rotation guidance system 40 are arranged together so as to ensure that the lifting-lowering guidance roller 72A enters the lifting-lowering guidance path when the rotation guidance roller 66A exits the rotation path of the rotation guidance track 66B.

The latching system 36 has a latching configuration for latching the door 18 in the closed position, in which the latching system 36 blocks the mechanical chain 34, and an unlatching configuration for unlatching the door 18 in the closed position, in which the latching system 36 does not obstruct the mechanical chain 34.

The latching phase of the door closing operation consists of the switching of the latching system 36 from the unlatching configuration (view A of FIG. 8) to the latching configuration (view B of FIG. 8). The unlatching phase of the door opening operation consists of the switching of the latching system 36 from the latching configuration to the unlatching configuration.

The latching system 36 is configured such that rotation of the drive shaft 32 relative to the aircraft structure 12 drives the switching of the latching system 36 from one of the configurations to the other.

More precisely, the latching system 36 is configured such that rotation of the drive shaft 32 relative to the aircraft structure 12 in the closing rotational direction drives the switching of the latching system 36 from the unlatching configuration to the latching configuration.

Conversely, the latching system 36 is configured such that rotation of the drive shaft 32 relative to the aircraft structure 12 in the opening rotational direction drives the switching of the latching system 36 from the latching configuration to the unlatching configuration.

The latching system 36 comprises at least one latching device 76. Preferably, the latching system 36 comprises at least two separate redundant latching devices 76. The two or more redundant latching devices 76 are arranged at a distance from each other along the control axis.

Each latching device 76 comprises at least one latching surface 78 for the mechanical chain 34; a latch 80 that is movable relative to the mechanical chain 34 and to the drive shaft 32; and a drive section 82 of the drive shaft 32 that is capable of driving the latch 80.

The shape and form of the latching surface 78, the latch 80, and the shape and form of the drive section 82 are configured together so as to ensure that the latching system 36 is maintained in the said configurations and so as to ensure the said switches of the latching system 36 from one of the configurations to the other, by means of rotation of the drive shaft 32 relative to the aircraft structure 12.

The latching surface 78 for the mechanical chain 34 may be formed by any element of the mechanical chain 34. In the preferred embodiment illustrated, the latching surface 78 of the mechanical chain 34 is formed by the lifting shaft 48.

The latching surface 78 thus then preferably extends radially relative to the lifting axis.

The latching surface 78 is positioned angularly about the lifting axis, such that when the lifting shaft 48 is decoupled from the rotation of the drive shaft 32, the latching surface 78 is disposed so as to face the latch 80.

The lifting shaft 48 thus then comprises, for example, a lift latching cam 84, with the latching surface 78 being formed by the lift latching cam 84.

The lift latching cam 84 is integral in rotation with the lifting rod 54, during any rotation of the lifting shaft 48 relative to the aircraft structure 12. The lift latching cam 84 is for example fastened to the lifting rod 54.

The lift latching cam 84 is constituted of a cylinder of variable radius centred on the control axis.

The lift latching cam 84 has a spiral form extending between a minimum radius and a maximum radius, with the latching surface 78 joining the minimum radius to the maximum radius.

The latch 80 is movable relative to the mechanical chain 34 between an abutment position abutting the latching surface 78 (view B of FIG. 8) and a release position for releasing the mechanical chain 34 (view A of FIG. 8).

In the latching configuration of the latching system 36, the latch 80 is in the abutment position and blocks the mechanical chain 34, with the drive shaft 32 still being rotationally movable about the drive axis. Given that the mechanical chain 34 is reversible, any movement of the door 18 relative to the aircraft structure 12 is then blocked by the latch 80.

In the unlatching configuration of the latching system 36, the latch 80 is maintained in the release position, some distance away from the mechanical chain 34, with the drive shaft 32 still being rotationally movable about the control axis.

The latch 80 is rotationally movable relative to the mechanical chain 34 along an axis of rotation parallel to the control axis.

Preferably, the latch 80 is capable of switching from the release position to the abutment position by rotating in the same direction as the closing rotational direction, and of switching from the abutment position to the release position by rotating in the same direction as the opening rotational direction.

The latch 80 is thus movable relative to the mechanical chain 34, in particular relative to the lifting shaft 48 of the mechanical chain 34. The latch 80 is movable relative to the drive shaft 32, in particular relative to the drive section 82 of the drive shaft 32. More generally, the latch 80 is rotationally movable along its axis of rotation relative to the aircraft structure 12.

The latch 80 has a base body 86A, a latch abutment 86B and at least two drive rollers 86C.

The latch abutment 86B extends from the base body 86A.

When the latch 80 is in the abutment position, the latch abutment 86B is positioned so as to face the latch surface 78 of the mechanical chain 34.

In the preferred embodiment illustrated, when the latch 80 is in the abutment position, the latch abutment 86B bars any rotation of the lift shaft 48 in the opening rotational direction.

The drive rollers 86C of the latch 80 are adapted so as to enable the drive section 82 of the drive shaft 32 to drive the latch 80 between the abutment and release positions.

Each drive roller 86C projects outwards from the base body 86A in a direction parallel to the control axis.

The drive rollers 86C are laterally offset, as projected in a plane perpendicular to the control axis. In other words, when projected in such a plane, the drive rollers 86C are not superposed.

The drive rollers 86C extend, for example, on either side of the base body 86A in a direction parallel to the control axis. Alternatively, the drive rollers 86C extend on a same given side of the base body 86A.

The drive section 82 is positioned away from the mechanical chain 34, and in particular from the lifting shaft 48, during any rotation of the drive shaft 32 relative to the aircraft structure 12. The drive section 82 is therefore free of any contact with the mechanical chain 34.

The drive section 82 of the drive shaft 32 is integral in rotation with the rest of the drive shaft 32, during any rotation of the drive shaft 32 relative to the aircraft structure 12.

The drive section 82 of the drive shaft 32 is capable of maintaining the latch 80 in the abutment position, maintaining the latch 80 in the release position, and driving the switching of the latch 80 from one of the positions to the other.

More precisely, the shape and form of the drive section 82 and the drive rollers 86C are: arranged in a manner such as to maintain the latch 80 in the release position during each door movement phase of the closing and opening operations; arranged in a manner such as to cause the switching of the latch 80 from one of the positions to the other during the latching phase of the closing operation and during the unlatching phase of the opening operation; and arranged in a manner such as to maintain the latch 80 in the abutment position during the other phases of the closing and opening operations.

The shape and form of the drive section 82 and the drive rollers 86C are arranged such that the latch 80 is maintained in the release position for as long as the control-lift connection system 50 couples the rotation of the drive shaft 32 to the movement of the door 18; and such that the latch 80 switches from the release position to the abutment position after the control-lift connection system 50 has decoupled the movement of the door 18 from the rotation of the drive shaft 32.

In addition, the shape and form of the drive section 82 and the drive rollers 86C are arranged so as not to block the rotation of the drive shaft 32 relative to the aircraft structure 12, during the latching and unlatching phases.

To achieve this, the drive section 82 comprises at least one drive cam 88 for the latch 80. Preferably, the drive section 82 comprises at least one different drive cam 88 for each drive roller 86C of the latch 80, with the drive cams 88 then being arranged to be mutually offset along the control axis. Alternatively, one single drive cam 88 is used for the two drive rollers 86C of the latch 80.

Each drive cam 88 is constituted of a cylinder of variable radius centred on the control axis.

Each drive cam 88 comprises an angular unlatching sector 90A and an angular latching sector 90B. Each drive cam 88 also comprises an angular transition sector 90C that joins the angular unlatching sector 90A to the angular latching sector 90B.

When the latch 80 is maintained in the release position, the drive rollers 86C are respectively in contact with the angular unlatching sectors 90A with the drive shaft 32 still being rotationally movable about the control axis.

When the latch 80 is maintained in the abutment position, the drive rollers 86C are respectively in contact with the angular latching sectors 90B, with the drive shaft 32 still being rotationally movable about the control axis.

Each angular unlatching sector 90A and each angular latching sector 90B has, for example, a constant radius, as measured from the control axis.

Preferably, for one of the drive cams 88, the radius of the angular unlatching sector 90A is greater than the radius of the angular latching sector 90B; and for the other of the drive cams 88, the radius of the angular latching sector 90B is greater than the radius of the angular unlatching sector 90A.

For each drive cam 88, the angular transition sector 90C has a variable radius, as measured angularly about the control axis, joining the radius of the angular unlatching sector 90A to the radius of the angular latching sector 90B of the drive cam 88.

The angular transition sectors 90C are positioned around the control axis so as to drive the switching of the latch 80 from one of the positions to the other.

Thus, during the door movement phase of the closing operation, rotation of the drive shaft 32 in the closing rotational direction maintains the latch 80 in the release position, due to the fact that the drive rollers 86C are in contact with the angular unlatching sectors 90A of the drive cams 88. The rotation of the lifting shaft 48 simultaneously drives the movement of the door 18 by the lift-door linking system 52 until such time as the door 18 reaches the closed position. Once the closed position has been reached, the lifting shaft 48 is decoupled from the rotation of the drive shaft 32, and the latching surface 78 of the lifting shaft 48 is then positioned so as to be facing the latch 80 with the latching surface 78 remaining in position during the subsequent phases. During the latching phase, rotation of the drive shaft 32 also drives the switching of the latch 80 from the release position to the abutment position, due to the fact that the drive rollers 86C are in contact with the angular transition sectors 90C of the drive cams 88. Once the abutment position has been reached, rotation of the drive shaft 32 in the closing rotational direction maintains the latch 80 in the abutment position, due to the fact that the drive rollers 86C are in contact with the angular latching sectors 90B of the drive cams 88.

Conversely, rotation of the drive shaft 32 in the opening rotational direction does not drive any movement of the door 18 relative to the aircraft structure 12 during the phases preceding the door movement phase of the opening operation. In addition, rotation of the drive shaft 32 in the opening rotational direction maintains the latch 80 in the abutment position during the phases preceding the unlatching phase. During the unlatching phase, rotation of the drive shaft 32 drives the switching of the latch 80 from the abutment position to the release position. Once the release position has been reached, rotation of the drive shaft 32 in the opening rotational direction maintains the latch 80 in the release position. Subsequently, once the rotation of the drive shaft 32 is coupled to the rotation of the lifting shaft 48 by the control-lift connection system 50, the rotation of the lifting shaft 48 simultaneously drives the movement of the door 18 by the lift-door linking system 52 during the door movement phase.

The latch locking system 38 has a latch locking configuration for locking the latch of the door 18 in the closed position, and a latch unlocking configuration.

The latch locking phase of the closing operation consists of the switching of the latch locking system 38 from the latch unlocking configuration (view A of FIG. 9) to the latch locking configuration (view B of FIG. 9). The latch unlocking phase of the opening operation consists of the switching of the latch locking system 38 from the latch locking configuration to the latch unlocking configuration.

The latch locking system 38 is configured so as to ensure that rotation of the drive shaft 32 relative to the aircraft structure 12 drives the switching of the latch locking system 38 from one of the configurations to the other.

More precisely, the latch locking system 38 is configured so as to ensure that rotation of the drive shaft 32 relative to the aircraft structure 12 in the closing rotational direction drives the switching of the latch locking system 38 from the latch unlocking configuration to the latch locking configuration.

Conversely, the latch locking system 38 is configured so as to ensure that rotation of the drive shaft 32 relative to the aircraft structure 12 in the opening rotational direction drives the switching of the latch locking system 38 from the latch locking configuration to the latch unlocking configuration.

The latch locking system 38 comprises at least one latch locking device 92. In the illustrated example, the latch locking system 38 comprises at least two separate redundant latch locking devices 92.

Each latch locking device 92 is respectively associated with one of the latching devices 76.

Each latch device 92 comprises a latch locking member 94A that is fixed to the latch 80 and a latch locking cam 94B for the latch 80, the latch locking cam 94B being fixed to the drive shaft 32.

The shapes and forms of the latch locking member 94A and the latch locking cam 94B are configured together so as to ensure that the latch system 38 is maintained in the said configurations and so as to ensure the said switches of the latch locking system 38 from one of the configurations to the other, by means of rotation of the drive shaft 32 relative to the aircraft structure 12.

In addition, the shapes and forms of the latch locking member 94A and the latch locking cam 94B are preferably configured so as not to block the rotation of the drive shaft 32 relative to the aircraft structure 12, in the latch locking and unlocking configurations.

The latch locking member 94A extends in a direction parallel to the control axis from the base body 86A of the latch 80. The latch locking member 94A is thus fastened to the base body 86A of the latch 80.

The latch locking member 94A extends, for example, on the same side as at least one of the drive rollers 86C, projecting beyond the drive roller 86C, in a direction parallel to the control axis.

The latch locking member 94A delimits a latch locking surface 96.

Preferably, the latch locking surface 96 is curved, advantageously being cylindrical along a central axis of curvature.

The latch locking member is arranged such that, in the abutment position of the latch 80, the central axis of curvature coincides with the control axis of the drive shaft 32.

The latch locking cam 94B is integral in rotation with the control rod 46, during any rotation of the drive shaft 32 relative to the aircraft structure 12. The latch locking cam 94B is, for example, fastened to the control rod 46.

The latch locking cam 94B comprises a base body 98A extending from the control rod 46 and a lock abutment 98B extending from the base body 98A.

The lock abutment 98B has a peripheral surface which is capable of cooperating with the latch locking surface 96.

The peripheral surface is, for example, cylindrical along the control axis.

In this case, the peripheral surface has a constant radius.

In the unlocking configuration of the latch locking system 38, the latch locking cam 94B is rotationally movable along the control axis, the latch locking abutment 98B being positioned at a distance from the latch locking member 94A (view A of FIG. 9).

In the latch unlocking configuration, the lock abutment 98B does not obstruct any movement of the latch 80 relative to the mechanical chain 34.

In the latch locking configuration of the latch locking system 38, the latch locking cam 94B is rotationally movable about the control axis, with the latch lock abutment 98B being positioned to be facing the latch locking member 94A, and the latch locking surface 96 co-operating with the peripheral surface of the latch lock abutment 98B so as to prevent any switching of the latch 80 from the abutment position to the release position (view B of FIG. 9).

In particular, in the latch locking configuration, the lock abutment 98B prevents any rotation of the latch 80 in the direction from the abutment position to the release position.

The latch locking cam 94B is positioned around the control axis so as to ensure that the latch locking surface 96 cooperates with the peripheral surface of the latch lock abutment 98B, after the latch 80 has switched into the abutment position.

Thus, during the door movement phase of the closing operation, the rotation of the drive shaft 32 in the closing rotational direction maintains the latch 80 in the release position, with the latch locking system 38 being in the unlocking configuration. The rotation of the lifting shaft 48 simultaneously drives the movement of the door 18 by the lift-door linking system 52 until such time as the door 18 reaches the closed position Once the closed position has been reached, the rotation of the drive shaft 32 also drives the switching of the latch 80 from the release position to the abutment position with the latch locking system 38 still being in the unlocking configuration. During the latch locking phase, once the abutment position has been reached, the rotation of the drive shaft 32 in the closing rotational direction maintains the latch 80 in the abutment position and causes the switching of the latch locking system 38 to the latch locking configuration, with the latch lock abutment 98B positioned so as to be facing the latch locking member 94A and the latch locking surface 96 co-operating with the peripheral surface of the latch lock abutment 98B.

Conversely, the rotation of the drive shaft 32 in the opening rotational direction does not drive any movement of the door 18 relative to the aircraft structure 12, during the phases preceding the door movement phase of the opening operation. In addition, the rotation of the drive shaft 32 in the opening rotational direction maintains the latch 80 in the abutment position, during the phases preceding the unlatching phase. During the latch unlocking phase, the rotation of the drive shaft 32 in the opening rotational direction drives the switching of the latch locking system 38 from the locking configuration to the latch unlocking configuration. The lock abutment 98B is driven some distance away from the latch locking member 94A. During the unlatching phase, the rotation of the drive shaft 32 drives the switching of the latch 80 from the abutment position to the release position. Once the release position has been reached, the rotation of the drive shaft 32 in the opening rotational direction maintains the latch 80 in the release position, with the latch locking system 38 still being in the unlocking configuration. Subsequently, once the rotation of the drive shaft 32 is coupled to the rotation of the lifting shaft 48 by the control-lift connection system 50, the rotation of the lifting shaft 48 simultaneously drives the movement of the door 18 by the lift-door linking system 52 during the door movement phase.

The pressure safety system 44 is configured so as to prevent passengers from opening the door 18 when the aircraft is pressurised above a certain pressure level, for example above 35 mbar.

Alternatively or additionally, the pressure safety system 44 is configured so as to prevent pressurisation of the aircraft, if the door 18 is not in the closed, latched position and with the latch securely locked.

The pressure safety system 44 is optional. The said safety functions may be implemented differently, for example electrically and/or by means of sensor and valve systems.

The pressure safety system 44 has a safe pressurisation configuration and a depressurisation configuration.

The safe pressurisation phase of the door closing operation consists of the switching of the pressure safety system 44 from the depressurisation configuration (view A of FIG. 10) to the safe pressurisation configuration (view B of FIG. 10). The depressurisation phase of the door opening operation consists of the switching of the pressure safety system 44 from the safe pressurisation configuration to the depressurisation configuration.

The safe pressurisation system is configured such that the rotation of the drive shaft 32 relative to the aircraft structure 12 drives the switching of the safe pressurisation system from one of the configurations to the other.

More precisely, the safe pressurisation system 44 is configured such that the rotation of the drive shaft 32 relative to the aircraft structure 12 in the closing rotational direction drives the switching of the safe pressurisation system 44 from the depressurisation configuration to the safe pressurisation configuration.

Conversely, the safe pressurisation system 44 is configured such that the rotation of the drive shaft 32 relative to the aircraft structure 12 in the opening rotational direction drives the switching of the safe pressurisation system 44 from the safe pressurisation configuration to the depressurisation configuration.

To this end, the pressure safety system 44 comprises at least one ventilation opening 100, a safety flap 102 that is movable relative to the aircraft structure 12 between a closed position which closes the ventilation opening 100 and a ventilation position arranged away from the ventilation opening 100, and a drive device 104 for driving the safety flap 102 between the closed and ventilation positions.

The safety flap 102 includes, for example, a return system for returning the safety flap 102 to the opening position, the return system comprising for example, a spring. The return system is not illustrated for reasons of clarity.

The safe pressurisation system 44 in addition preferably comprises an additional latching device for latching the door 18 in the closed position closed by the safety flap 102.

The ventilation opening 100 is delimited by the aircraft structure 12.

For example, the ventilation opening 100 is delimited by aircraft structure 12 below the boarding opening 16.

Thus, the safe pressurisation system 44 is not integrated into the door 18, but rather into the aircraft structure 12.

The safety flap 102 is hinge-jointed (articulated) to the aircraft structure 12.

In particular, the safety flap 102 is thus then rotationally movable relative to the aircraft structure 12 between the two positions, along an axis of rotation that is, for example, parallel to the control axis.

In the safe pressurisation configuration, the safety flap 102 is in the closed position for closing the ventilation opening 100 (view B in FIG. 10).

In the closed position, the safety flap 102 is sealingly pressed against the ventilation opening 100. The safety flap 102 thus prevents any passage of air from the interior of the aircraft structure 12 to the exterior of the aircraft structure 12 through the ventilation opening 100.

In the depressurisation configuration, the safety flap 102 is in the ventilation position arranged away from the ventilation opening 100 (view A in FIG. 10).

In the ventilation position, the safety flap 102 is arranged away from the ventilation opening 100. The air within the interior of the aircraft structure 12 passes to the exterior of the aircraft structure 12 through the ventilation opening 100.

It is thus then impossible to pressurise the aircraft.

The drive device 104 is configured so as to ensure the switching of the safety flap 102 from one of these positions to the other, by means of rotation of the drive shaft 32 relative to the aircraft structure 12.

The drive device 104 is also configured so as to ensure that the safety flap 102 is maintained in the closed position.

In one illustrated embodiment, the drive device 104 of the safety flap 102 comprises a drive finger that is fixed to the drive shaft 32 and a drive stop that is fixed to the safety flap 102.

The drive finger is preferably integral in rotation with the control rod 46 during any rotation of the drive shaft 32 relative to the aircraft structure 12.

For example, the drive finger is fixed to the control rod 46 by means of a cam. In the example shown, the said cam corresponds to the latch locking cam 94B and the drive finger is fixed to the base body of the latch locking cam 94B. Alternatively, the drive finger is fixed to any other cam. In one other embodiment, the drive finger is fixed to the drive shaft 32 by means of a system of one or more connecting rod(s).

The drive finger extends in a direction parallel to the control axis.

The drive finger and drive stop are arranged so as to drive the safety flap 102 from the ventilation position to the closed position, after the latch locking system 38 has switched into the latch locking configuration.

The additional latching device is complementary to the latching devices 76 of the latching system 36.

The additional latching device is configured so as to block the mechanical chain 34, when the safety flap 102 is in the closed position.

The door status sensor system 18 is configured so as to determine a current status of the door 18.

The current status of the door 18 for example, is selected from at least: an open status; a closed and latched status; and a closed and latched and locked status.

The open status corresponds to the door 18 being in a position other than the closed position.

The closed and latched status corresponds to the door 18 being in the closed position and the latching system 36 being in the latching configuration.

The closed and latched and locked status corresponds to the door 18 being in the closed position, the latching system 36 being in the latching configuration, and the latch locking system 38 being in the latch locking configuration.

The closed and latched and locked status corresponds in particular to the state after the closing operation has concluded.

The sensors are thus then for example, switches that are capable of being actuated by the control system 20.

Each visual indicator presents a configuration based on the current status of the door 18. Each indicator is for example a light and/or a mechanical indicator comprising, for example, a movable flap.

The emergency opening system is capable of enabling the evacuation of passengers from the aircraft in the event of danger, and/or in the event of damage that is not dangerous.

The emergency opening system is capable of effectuating rotation of the drive shaft 32 in the opening rotational direction.

The emergency opening system, for example, is electrical and has an emergency switch which, when actuated, is capable for controlling the actuator of the control system 20.

By way of a variant or an addition, the emergency opening system comprises an interior handle within the interior of the aircraft structure 12 and/or an exterior handle on the exterior of the aircraft structure 12. The emergency opening system is thus then configured so as to ensure that the actuation of the handle effectuates rotation of the drive shaft 32 in the opening rotational direction.

In this instance, and subsequently, the term “actuation of the handle” is understood to refer to, for example, a movement of the handle relative to the aircraft structure. 12

The concept of the present disclosure is thus compatible with simple emergency and/or recovery handles.

In a more general manner, the interior handle within and the exterior handle on the exterior of the aircraft structure are not necessarily included in an emergency opening system, but may be used for the execution of the opening operation as well as for the execution of the closing operation. The control system 20 is thus then configured so as to ensure that the actuation of the exterior handle and/or the exterior handle effectuates rotation of the drive shaft 32 relative to the aircraft structure 12 in order to control the execution of the said operations.

Thanks to the characteristic features described above, there is found to be a significant improvement in many respects, without any disadvantages or risks.

In particular, there is a notable reduction in the mass of the mechanism 10, the number of mechanical parts, the number of kinematic links, the overall physical footprint, and the stresses on the structure of door 18.

The robustness of the mechanism 10 is greatly enhanced, given that the mechanism 10 requires only one actuator in order to control the opening and closing of the door 18.

The mechanism 10 no longer requires an interior handle on the door 18, which implies that it is possible to obtain a greater useful width of the door 18 while increasing the spacing distance between the railings 26 of the staircase 24. In addition, the mechanism 10 no longer requires an exterior handle, which implies enhanced aerodynamics.

The acoustics of the door 18 are also greatly improved, as the mechanism 10 no longer requires valves integrated into the door 18 in order to perform the safe pressurisation functions as required by regulations.

In addition, the number of visible mechanical parts has been reduced, thereby resulting in improved ergonomics and perceived quality.

What is claimed is:

1. An aircraft door mechanism comprising at least:
an aircraft structure that delimits an opening;
an aircraft door mounted so as to be movable relative to the aircraft structure between a closed position, in which the door closes the opening, and a boarding position, in which the door is arranged away from the opening and in which passengers are able to board the aircraft structure through the opening;
a control system configured so as to control an execution of a closing operation and the execution of an opening operation of the door,
the door closing operation successively comprising: a door movement phase of moving the door relative to the aircraft structure from the boarding position to the closed position; a door latching phase of latching the door in the closed position; a door latch locking phase of locking the latching of the door;
the door opening operation successively comprising: a door latch unlocking phase of unlocking a latching of the door in the closed position, an unlatching phase of unlatching the door, and a door movement phase of moving the door relative to the aircraft structure from the closed position to the boarding position;
the control system comprising a drive shaft, with the control system being configured so as to control the execution of the said operations by means of continuous rotation of the drive shaft relative to the aircraft structure.

2. The aircraft door mechanism according to claim 1, wherein the drive shaft is arranged away from the aircraft door.

3. The aircraft door mechanism according to claim 1, wherein the control system also comprises at least one mechanical chain that joins the drive shaft to the door, a latching system for latching the door in the closed position, and a latch locking system for locking the latching of the door in the closed position.

4. The aircraft door mechanism according to claim 3, wherein the mechanical chain has a coupling mode for coupling the rotation of the drive shaft to the movement of the door, during each door movement phase of the door closing and opening operations; and a decoupling mode for decoupling the door from the rotation of the drive shaft, during the door latching phase and the door latch locking phase of the closing operation, and during the door latch unlocking phase and the door unlatching phase of the opening operation, the mechanical chain being configured such that the rotation of the drive shaft relative to the aircraft structure drives a switching of the mechanical chain from one of the modes to the other.

5. The aircraft door mechanism according to claim 4, wherein the mechanical chain comprises a lifting shaft, a control-lift connection system between the drive shaft and the lifting shaft, and a lift-door linking system between the lifting shaft and the door.

6. The aircraft door mechanism according to claim 5, wherein the control-lift connection system comprises at least one pair of connection members, the pair of connection members comprising a control connection member that is fixed to the drive shaft; and a lift connection member that is fixed to the lifting shaft, the control connection member and the lift connection member being capable of rotationally coupling the drive shaft and the lifting shaft in the coupling mode and of decoupling the lifting shaft from the rotation of the drive shaft in the decoupling mode.

7. The aircraft door mechanism according to claim 6, wherein either one of the control connection member and the lift connection member comprises a connection roller while the other one of the control connection member and the lift connection member comprises a connection track that is capable of receiving the connection roller.

8. The aircraft door mechanism according to claim 7, wherein the connection track comprises a coupling travel such that, in the coupling mode of the mechanical chain, the coupling travel and the connection roller are capable of rotationally coupling the drive shaft and the lifting shaft, and such that, in the decoupling mode of the mechanical chain, the roller is outside the coupling travel.

9. The aircraft door mechanism according to claim 8, wherein the connection track also comprises a dead travel, the dead travel being such that, in the decoupling mode of the mechanical chain, the connection roller is either received in the dead travel or is outside the connection track.

10. The aircraft door mechanism according to claim 5, wherein the lift-door linking system comprises at least one pair of linking members, the pair of linking members comprising a lift linking member that is fixed to the lifting shaft, and a door linking member that is fixed to the door, the lift linking member being articulated to the door linking member.

11. The aircraft door mechanism according to claim 3, wherein the latching system has a latching configuration for latching the door in the closed position, in which the latching system blocks the mechanical chain; and an unlatching configuration for unlatching the door in the closed position, in which the latching system does not obstruct the mechanical chain, the latching system being configured so as to ensure that rotation of the drive shaft relative to the aircraft structure drives a switching of the latching system from one of the configurations to the other.

12. The aircraft door mechanism according to claim 11, wherein the latching system comprises at least one latching surface for the mechanical chain, a latch that is movable relative to the mechanical chain and to the drive shaft, and a drive section of the drive shaft that is capable of driving the latch, with the latching surface.

13. The aircraft door mechanism according to claim 12, wherein the mechanical chain comprises a lifting shaft, a control-lift connection system between the drive shaft and the lifting shaft, and a lift-door linking system between the lifting shaft and the door, wherein the latching surface is formed by the lifting shaft.

14. The aircraft door mechanism according to claim 12, wherein a shape and form of the latching surface, the latch, and the shape and form of the drive section of the drive shaft are configured together so as to ensure that the latching system is maintained in the said configurations and so as to ensure the said switches of the latching system from one of the configurations to the other, by means of rotation of the drive shaft relative to the aircraft structure.

15. The aircraft door mechanism according to claim 3, wherein the latch locking system has a latch locking configuration for locking the latch of the door in the closed position, and a latch unlocking configuration, the latch locking system being configured such as to ensure that the rotation of the drive shaft relative to the aircraft structure drives a switching of the latch locking system from one of the configurations to the other.

16. The aircraft door mechanism according to claim 15, wherein the latching system comprises at least one latching surface for the mechanical chain, a latch that is movable relative to the mechanical chain and to the drive shaft, and a drive section of the drive shaft that is capable of driving the latch, with the latching surface, wherein the latch locking system comprises at least one latch locking member that is fixed to the latch and a latch locking cam for the latch that is fixed to the drive shaft, shapes and forms of the latch locking member and of the latch locking cam being configured together in order to ensure that the latch locking system is maintained in the said configurations and in order to ensure the said switches of the latch locking system from one of the configurations to the other, by means of rotation of the drive shaft relative to the aircraft structure.

17. The aircraft door mechanism according to claim 3, wherein the control system also comprises a pressure safety system, the pressure safety system comprising at least one ventilation opening delimited by the aircraft structure, a safety flap that is movable relative to the aircraft structure between a closed position which closes the ventilation opening and a ventilation position arranged away from the ventilation opening; and a drive device for driving the safety flap between the closed and ventilation positions, the drive device being configured so as to ensure a switching of the safety flap from one of the said positions to the other, by means of rotation of the drive shaft relative to the aircraft structure.

18. The aircraft door mechanism according to claim 1, wherein the control system also comprises an actuator configured for rotating the drive shaft relative to the aircraft structure in order to control the execution of the said operations by means of continuous rotation of the drive shaft.

19. The aircraft door mechanism according to claim 18, wherein the actuator is electrical.

20. The aircraft door mechanism according to claim 1, wherein the control system also comprises an interior handle on the interior of the aircraft structure, the control system being configured such that actuation of the interior handle effectuates rotation of the drive shaft relative to the aircraft structure in order to control the execution of the said operations; and/or the control system also comprises an exterior handle on the exterior of the aircraft structure, the control system being configured such that actuation of the exterior handle effectuates rotation of the drive shaft relative to the aircraft structure in order to control the execution of the said operations.
